(19) United States
(12) Patent Application Publication
(10) Pub. No.: US 2007/0002405 A1
(43) Pub. Date: Jan. 4, 2007

(54) Display apparatus, color calibration system and method thereof

(75) Inventors: In-hye Lee, Suwon-si (KR); Young-chan Kim, Uiwang-si (KR); Yun-ju Hong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/475,140

(22) Filed: Jun. 27, 2006

(30) Foreign Application Priority Data
Jul. 4, 2005 (KR) 2005-59923

(51) Int. Cl. H04N 1/46

(52) U.S. Cl. 358/504

(57) ABSTRACT

A display apparatus includes a display unit, a flash ROM that is provided in a microcomputer to drive the display unit and has a given color data area preset, and a color calibration unit to calibrate color in the display unit according to color data arrangement recorded on the color data area of the flash ROM.

### CROSS-REFERENCE TO RELATED APPLICATIONS

This application claims priority from Korean Patent Application No. 2005-0059923, filed on Jul. 4, 2005, in the Korean Intellectual Property Office, the disclosure of which is incorporated herein by reference.

### BACKGROUND OF THE INVENTION

1. Field of the Invention

The present general inventive concept relates to a display apparatus to calibrate color of an image, a color calibration system using the display apparatus, and a method thereof, and more particularly, to a display apparatus, a color calibration system and a method thereof which are capable of calibrating color of a displayed image.

2. Description of the Related Art

In general, a display apparatus provides an image to a user by processing an image signal supplied from a signal source that may be an information processing apparatus such as a computer and the like. The image signal in a given color mode, e.g., a gray mode, a RGB mode, a CYMK mode or the like, is provided from the signal source and is adjusted to have a gain value of each color through given signal processing in the display apparatus and displayed as the image of various colors in a display unit.

There have been various needs to satisfy finer and higher definition of the display apparatus and to calibrate color of the image displayed in the display apparatus to obtain an optimum moving image conforming to a demand for multimedia. Accordingly, a volume of color data of the image becomes larger and requires a high capacity. Further, it has been increasingly required to calibrate color of the image displayed in the display apparatus more finely, so that the color of the image displayed in the display apparatus may be coincided with that of actually printed output.

The color data of the image displayed by the display unit of display apparatus can be detected by means of a separate detecting unit. If a large volume of the color data must be upgraded to calibrate color of the image displayed in the display apparatus based on the color data that is detected by the detecting unit. An external memory such, as an EEPROM, is required in order to store the color data.

Moreover, there have been demands on a speed of the upgrade operation for the color data by assigning a certain region to a color data region in an internal RAM embedded in a microcomputer for driving respective units of the display apparatus, and loading the color data collectively from the external memory to be upgraded. It is also possible to carry out the upgrade operation using not the external RAM instead of the internal RAM.

FIG. 7 is a view illustrating internal area assignment in a flash ROM and a RAM in a display apparatus. Referring to FIG. 7, the ROM includes a program codes area 70a in which program codes are stored for driving the display apparatus, and other given area 70b which are assigned to the flash ROM embedded in the microcomputer for driving the conventional display apparatus. However, a separate area for storing color data is not assigned. Therefore, in performing the color calibration in the conventional display apparatus, it results in a lower execution speed of an upgrade operation compared to higher costs due to usage of the external memory such as EEPROM.

Further, even in a case of using the RAM internally or externally provided in a microcomputer of the conventional display apparatus, since certain areas must be assigned to a color data area 80b, which is other than general RAM areas 80a, 80c set within the RAM for processing data generally, it causes a shortage of a work space for any other necessary processing operation.

### SUMMARY OF THE INVENTION

An aspect of the present general inventive concept provides a display apparatus, and a color calibration system, and a method thereof which can increase an operation speed for color calibration and can be more simplified without a separate external memory, by assigning color data area to a flash ROM prepared within a microcomputer of the display apparatus.

Additional aspects and advantages of the present general inventive concept will be set forth in part in the description which follows and, in part, will be obvious from the description, or may be learned by practice of the general inventive concept.

The present general inventive provides a display apparatus, and a color calibration system, and a method thereof which can increase an execution velocity for color calibration and can be more simplified without a separate external memory, by assigning the color data area to a flash ROM prepared within a microcomputer of the display apparatus.

The foregoing and/or other aspects of the present general inventive concept may be achieved by providing a display apparatus having a display unit to display an image, the display apparatus comprising a flash ROM that is provided in a microcomputer to drive the display unit and has a given color data area preset, and a color calibration unit to calibrate color of the image in the display unit according to color data arrangement recorded in the color data area of the flash ROM.

The color data arrangement according to a color calibration file generated in an external information processing apparatus may be recorded in the color data area of the flash ROM according to a given control signal.

The control signal may be processed based on an ISP command from the information processing apparatus.

The foregoing and/or other aspects of the present general inventive concept may also be achieved by providing a color calibration system having an information processing apparatus and a display apparatus connected with the information processing apparatus, wherein the display apparatus comprises a display unit to display an image, a flash ROM that is provided in a microcomputer for driving the display unit and has a given color data area preset, and a color calibration unit to calibrate color of the image in the display unit according to a color data arrangement recorded in the color data area of the flash ROM, and the information processing apparatus generates a color calibration file having the color data arrangement and records the color data arrangement of the color calibration file in the color data area of the flash ROM according to a given control signal.

The information processing apparatus records the color data arrangement in the color data area of the flash ROM according to an ISP command-based control signal on a basis of the generated color calibration file.

The color calibration system may further comprise a detecting unit to detect an image pattern of the image displayed in the display unit.

The information processing apparatus records the color data arrangement of a given reference color calibration file in the color data area, if the color data arrangement of the image pattern detected by the detecting unit is different from that of a given reference color pattern.

The foregoing and/or other aspects of the present general inventive concept may also be achieved by providing a color calibration method of a display apparatus having a display unit and a microcomputer with a flash ROM being embedded, the method comprising presetting a given area of the flash ROM as a color data area, generating a color calibration file having a color data arrangement, recording the color data arrangement of the color calibration file in the color data area, and calibrating color of the display unit according to the color data arrangement recorded in the color data area.

The color calibration method may further comprise recording the corresponding color data arrangement in the color data area by compiling the color calibration file, and ascertaining whether the color data arrangement is recorded on the color data area by reading out an execution file generated in conjunction with the compiling of the color calibration file.

The color calibration method may further comprise preparing a reference color calibration file having the color data arrangement corresponding to a given reference color pattern, and recording the color data arrangement of the reference color calibration file in the color data area.

The color calibration method may further comprise detecting an image pattern displayed in the display unit, and recoding the color data arrangement of the reference color calibration file in the color data area, if the color data arrangement of the detected image pattern is different from that of the reference color pattern.

The color calibration method may further comprise preparing an information processing apparatus connected with the display apparatus, and recording the color data arrangement in the color data area according to an ISP command-based control signal by generating each of the files in the information processing apparatus.

The foregoing and/or other aspects of the present general inventive concept may also be achieved by providing a display apparatus comprising a display unit to display an image thereon, a microcomputer having a flash ROM having a preset program code area to store a program code and a preset color date area to store color data arrangement of a color calibration file, and a color calibration unit to calibrate color corresponding to the image in the display unit according to the color data arrangement stored in the preset color data area of the flash ROM.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic structure diagram illustrating a display apparatus and a color calibration system according to an embodiment of the present general inventive concept.

FIG. 2 is a view illustrating area assignment in a flash ROM of the display apparatus of FIG. 1.

FIG. 3 is a flow diagram of a color calibration method in a display apparatus according to an embodiment of the present general inventive concept.

FIG. 4 is a view illustrating a store position set in a color calibration file according to an embodiment of the present general inventive concept;

FIG. 5 is a view illustrating color data arrangement contained in the color calibration file of FIG. 4;

FIG. 6 is a view illustrating an execution file of the color calibration file read out from a flash ROM according to an embodiment of the present general inventive concept; and

FIG. 7 is a view illustrating internal area assignment in a flash ROM and a RAM in a conventional display apparatus.

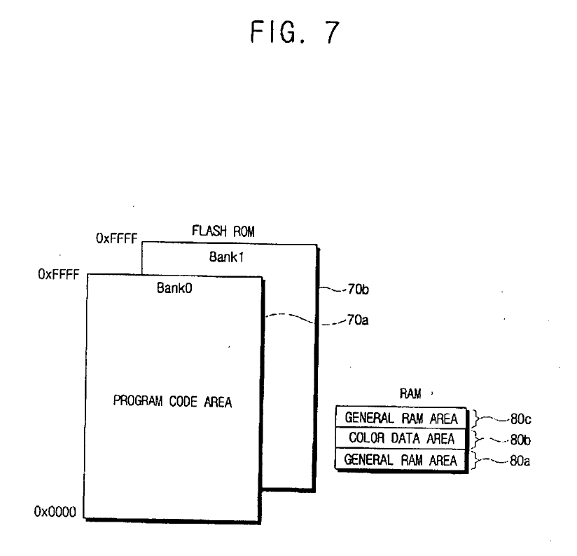

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

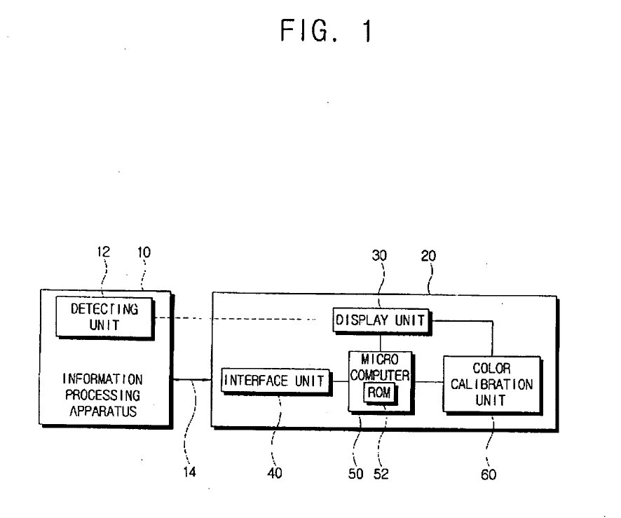

FIG. 1 is a schematic diagram illustrating a display apparatus 20 and a color calibration system with the same according to an embodiment of the present general inventive concept. As illustrated in FIG. 1, the display apparatus 20 includes an interface unit 40 to which color data is inputted from an outside thereof, a display unit 30 which displays an image based on the color data provided from the interface unit 40, a color calibration unit 60 which calibrates color of the image displayed in the display unit 40, and a microcomputer 50 to drive the display unit 30, the color calibration unit 60, and other units therein.

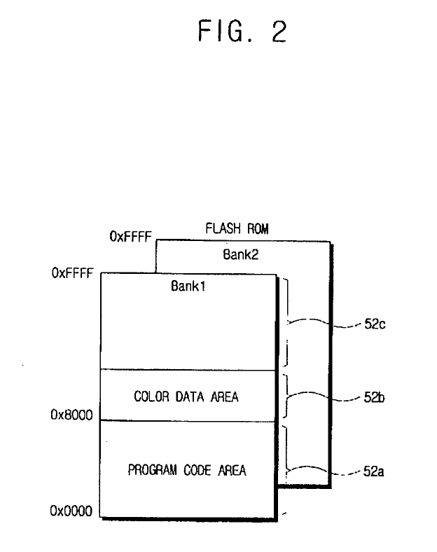

A flash memory is embedded in the microcomputer 50 to store various data necessary to operate the display apparatus. The flash memory in the present embodiment is embodied as a flash ROM 52. As illustrated in FIG. 2, the flash ROM 52 includes a color data area 52b to store given color data, and a program code area 52a to store program code data that is used to drive the display unit 30 and other components. The color data area 52b and the program code area 52a are preset in the flash ROM 52. Accordingly the color calibration unit 60 is configured to calibrate color of the image in the display unit 30 according to color data arrangement recorded in the color data area 52b of the flash ROM 52. The flash ROM 52 may further include other area 52c to store data generating during an operation of the program code data.

Here, the color data arrangement according to a color calibration file generated in an external information processing apparatus 10 is recorded in the color data area 52b of the flash ROM 52 based on a predetermined control signal. The control signal sent from the information processing apparatus 10 to the display apparatus 20 is implemented based on an ISP (In-System Programming) command. In a case of a recording, reading or deleting operation, the color data is stored on the flash ROM 52 embedded in the microcomputer 50, and the recording, reading or deleting operation is carried out internally through signal processing of this system based on the ISP command.

Since an external memory (e.g., EEPROM) is required to be mounted in a conventional display apparatus, it is necessary that the external memory is detached in order to record any data therein, or that an additional device, such as a ROM writer, is used to record corresponding data in a corresponding memory. However, in the present embodiment, since a recording/reading operation may be carried out on an internal flash memory based on the ISP command, it is not necessary to detach the corresponding memory or to use the additional recording device and additional external memory, thereby simplifying processes and reducing manufacturing costs.

On the other hand, the information processing apparatus 10 which provides the color data according to the color calibration file serves as a control apparatus to calibrate the color and is connected with the interface unit 40 of the display apparatus 20 via a given signal line 14. Here, the signal line 14 and the interface unit 40 may be prepared to be adapted for various transfer modes, such as a USB mode, a serial port mode, a DDC mode or the like. Consequently, the color data provided from the information processing apparatus 10 to be recorded on the flash ROM 52, may be sent to the display apparatus 20 through a given terminal pin (not shown) prepared in the interface unit 40.

As illustrated in FIG. 1, the color calibration system according to the embodiment of the present invention includes the information processing apparatus 10 and the display apparatus 20 connected with the information processing apparatus 10. Therefore, the information processing apparatus 10 may generate the color calibration file having color data arrangement and send the color data arrangement of the color calibration file to the display apparatus 20 in accordance with a given ISP command-based control signal.

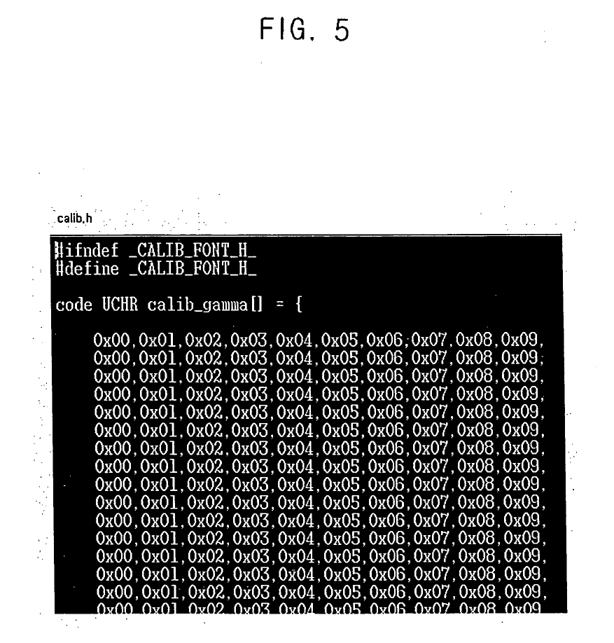

The color calibration file having color data arrangement is exemplified as ‘calib.c,’ and the color data area 52b of the flash ROM 52 is set in a ‘0x8000’ address area in ‘Bank1’ as illustrated in FIG. 2. The color data may have the data arrangement, such as ‘calib_gamma□,’ as shown in FIG. 5. Meanwhile, any other areas than the color data area 52b in ‘Bank1’ of the flash ROM 52 are assigned to the program code area 52a in which any program code data is stored, and the other area 52c.

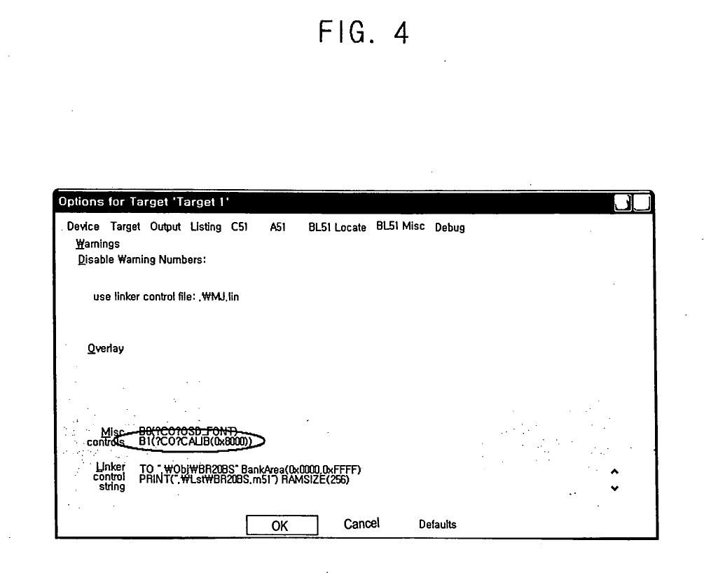

Consequently, a compile option may be set to be “B1(?CO?CALIB(0X8000)” as shown in FIG. 4, in order to cause the color calibration file ‘calib.c’ to be located in the ‘0X8000’ address area corresponding to the color data area 52b.

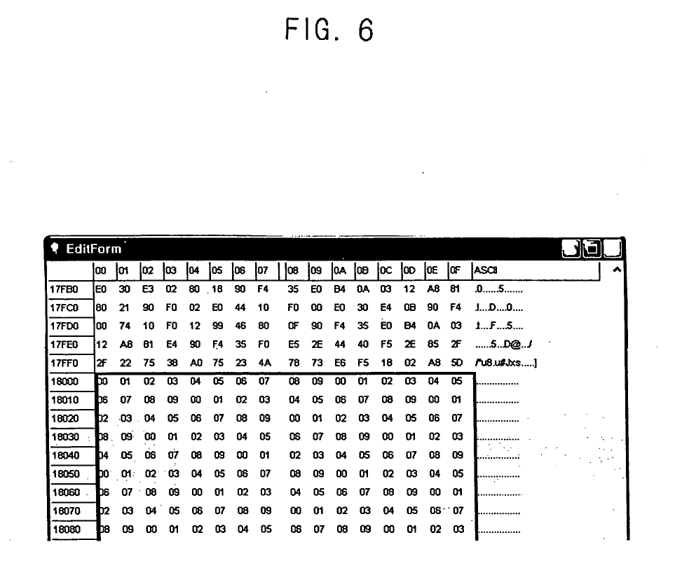

The color data arrangement is recorded at corresponding address of the ‘0X8000’ address area which is the color data area 52b preset in the flash ROM 53 by compiling the color calibration file with the above compile option. After the color data arrangement is recorded in the corresponding address area, an execution file generated by the compile may be read out. Then, it is possible for a user to ascertain whether the color data arrangement is recorded in corresponding ‘0X8000’ address area of the color data area 52b using a given window displayed in the display unit 30 as shown in FIG. 6.

Meanwhile, the color calibration system according to the present embodiment further includes a detecting unit 12 which detects an image pattern displayed in the display unit 30. In the present embodiment, although the detecting unit 12 is exemplified as being attached to the information processing apparatus 10, it may be provided separately from the information processing apparatus 10. Further, the detecting unit 12 may be provided in a predetermined position of the display apparatus so that it may send the detected color data to the information processing apparatus 10 via a separate signal line (not shown).

The information processing apparatus 10 is provided with the detected signal regarding to color data of the image displayed in the display unit from the detecting unit 12. Therefore, the information processing apparatus 10 may determine whether it coincides with set value regarding to a gain value for each color through the color calibration process based on the detected signal. In accordance with the determined results, in a case of calibrating the color of the image displayed in the display unit 30 according to the detected signal from the detecting unit 12, the display apparatus 20 may be provided with the color data arrangement according to the color calibration file as described above.

Also, the information processing apparatus 10 may be structured to prepare a reference color calibration file having color data arrangement corresponding to a given reference color pattern, and to record the color data arrangement of the reference color calibration file in the color data area 52b of the flash ROM 52 embedded in the microcomputer 50 of the display apparatus 20.

Here, the reference color pattern may be prepared as various color profile based on given color coordinate values, and may be set in a color mode, for example, a gray mode, an RGB mode, a CYMK mode or the like. Additionally, the reference color pattern may be set in a desired-skin color mode, a grass color mode, and a sky color mode which make a reference to a desired-skin color, a grass color, and a sky color. Further, the reference color pattern may be set according as the color mode for a steady (still) image and the color mode for a moving image are set differently from each other by discriminating the steady image and the moving image.

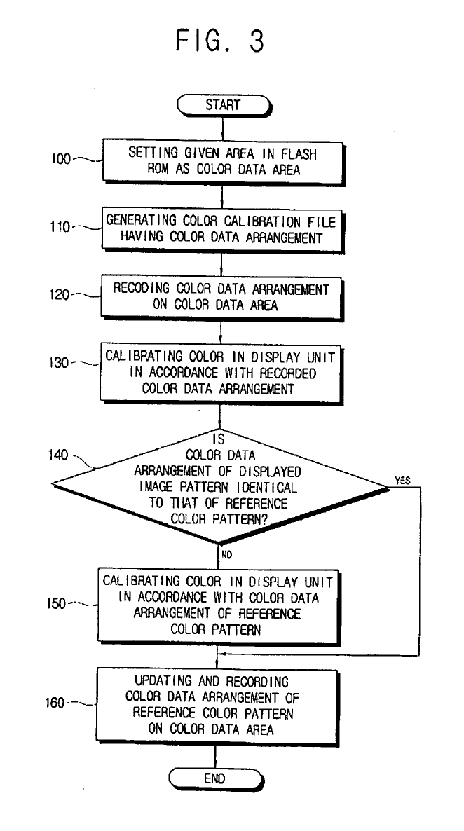

A color calibration method of the display apparatus according to the embodiment of the present general inventive concept as described above will be now described with reference to a flow diagram of FIG. 3 and the display apparatus of FIGS. 1 and 2.

The method presets a given area in the flash ROM 52 embedded in the microcomputer 50 of the display apparatus 20 as the color data area 52b at operation 100. It generates a color calibration file (above-described ‘calib.c’ file) having the color data arrangement at the information processing apparatus 10 connected with the display apparatus 20 at operation 110. Accordingly, the information processing apparatus 10 may record the color data arrangement of the color calibration file generated based on the ISP command, in the color data area 52b of the flash ROM 52 embedded in the microcomputer 50 of the display apparatus 20 at operation 120. The color calibration unit 60 of the display apparatus 20 calibrates the color in display unit 30 in accordance with the color data arrangement recorded in the color data area 52b before displaying the image at operation 130.

Here, the information processing apparatus 10 may generate a reference color calibration file having the color data arrangement corresponding to a given reference color pattern as described above, and may record the color data arrangement of the reference color calibration file in the color data area of the flash ROM based on the ISP command.

Further, the detecting unit 12 may detect the image pattern of the image displayed in the display unit 30, and determine whether the color data arrangement of the detected image pattern is identical to that of the reference color pattern at operation 140. If both the color data arrangements are different with each other, the color data arrangement of the reference color calibration file will be upgraded and then recorded in the color data area 52b at operation 150, thereby to calibrate the color of the image in the display unit 30 before displaying the image at operation 160. If both the color data arrangements are same, the display unit 30 may display the image calibrated in accordance with the color data arrangement of the reference color calibration file at operation 160.

Moreover, upon recording the color data arrangement in the color data area 52b of the flash ROM 52, it is possible to record corresponding color data arrangement in the color data area 52b by compiling the color calibration file, and ascertain whether the color data arrangement has been recorded in the color data area 52b by reading out an execution file generated in conjunction with the compile of the color calibration file.

Meanwhile, the display apparatus 20 may include a signal processing unit (not shown) which processes an image signal to be input, and a converting unit (not shown), such as a scalar, which converts the image signal applied from the signal processing unit into a format capable of displaying in the display unit 30.

The display apparatus according to the embodiment of the present general inventive concept as described above, can achieve easiness and improvement of an execution speed of color calibration during a manufacturing process, and also can make easier to maintain even in a case of a color calibration failure of a user. Further, it is possible to make the user calibrate directly in the display apparatus to any desired colors by providing the user with a color calibration tool according to the present embodiment. That is, the color in the display unit can be calibrated based on the color data stored in color data area of the flash ROM using a user input unit such as OSD adjusting buttons prepared in the display apparatus. Further, the display system can also calibrate brightness, luminosity or the like that are other than color.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus having a display unit, comprising:
a flash ROM which is provided in a microcomputer to drive the display unit and which has a preset color data area; and
a color calibration unit to calibrate color in the display unit according to color data arrangement recorded in the preset color data area of the flash ROM.

2. The display apparatus according to claim 1, wherein the color data arrangement is recorded in the color data area of the flash ROM according to a color calibration file generated in an external information processing apparatus and a given control signal.

3. The display apparatus according to claim 2, wherein the control signal is processed based on an ISP command from the external information processing apparatus.

4. A color calibration system comprising:
a display apparatus comprising a display unit, a flash ROM that is provided in a microcomputer to drive the display unit and has a preset color data area-, and a color calibration unit to calibrate color in the display unit according to a color data arrangement recorded in the preset color data area of the flash ROM; and
an information processing apparatus to generate a color calibration file having the color data arrangement and to record the color data arrangement of the color calibration file in the preset color data area of the flash ROM a given control signal.

5. The color calibration system according to claim 4, wherein the information processing apparatus records the color data arrangement in the preset color data area of the flash ROM in accordance with a ISP(In-System Programming) command-based control signal on a basis of the generated color calibration file.

6. The color calibration system according to claim 4, further comprising:
a detecting unit to detect an image pattern displayed in the display unit.

7. The color calibration system according to claim 5, wherein the information processing apparatus records the color data arrangement of a given reference color calibration file in the color data area, if the color data arrangement of the image pattern detected by the detecting unit is different from that of a given reference color pattern.

8. A color calibrating method, the method comprising:
presetting a given area of a flash ROM embedded in a microcomputer of a display apparatus having a display unit to display an image thereof, as a color data area;
generating a color calibration file having a color data arrangement;
recording the color data arrangement of the color calibration file in the color data area; and
calibrating color of the display unit according to the color data arrangement recorded in the color data area.

9. The color calibration method according to claim 8, further comprising:
recording the corresponding color data arrangement in the color data area by compiling the color calibration file; and
ascertaining whether the color data arrangement is recorded in the color data area by reading out an execution file generated in conjunction with the compiling of the color calibration file.

10. The color calibration method according to claim 9, further comprising:
preparing a reference color calibration file having the color data arrangement corresponding to a given reference color pattern; and
recording the color data arrangement of the reference color calibration file in the color data area.

11. The color calibration method according to claim 8, further comprising:
detecting an image pattern displayed in the display unit; and
recoding the color data arrangement of the reference color calibration file in the color data area, if the color data arrangement of the detected image pattern is different from that of the reference color pattern.

12. The color calibration method according to claim 8, further comprising:
preparing an information processing apparatus connected with the display apparatus; and
recording the color data arrangement in the color data area according to an ISP command-based control signal by generating the color calibration file in the information processing apparatus.

13. A display apparatus, comprising:
a display unit to display an image thereon:
a microcomputer having a flash ROM having a preset program code area to store a program code and a preset color date area to store color data arrangement of a color calibration file; and
a color calibration unit to calibrate color corresponding to the image in the display unit according to the color data arrangement stored in the preset color data area of the flash ROM.

14. The display apparatus according to claim 13, wherein the flash ROM comprises a preset memory area to store data generated during operating the program code.

15. The display apparatus according to claim 14, wherein the color data arrangement is not stored in the preset program code area and the preset memory area.

16. The display apparatus according to claim 14, wherein the color data arrangement is not randomly stored in the flash ROM.

17. The display apparatus according to claim 13, wherein the flash ROM is divided into a first area corresponding to the preset program code area, a second area corresponding to the preset color data area, and a third area corresponding to a preset memory area to store data generated during an operation of the program code.

18. The display apparatus according to claim 13, wherein display unit, the microcomputer, and the color calibration unit are disposed in a single body.
